(19) United States
(12) Patent Application Publication
(10) Pub. No.: US 2009/0278707 A1
(43) Pub. Date: Nov. 12, 2009

(54) WEAR MONITOR FOR RECREATIONAL FOOTGEAR

(75) Inventors: James F. Biggins, Waltham, MA (US); Todd A. Peavey, Denver, CO (US)

Correspondence Address: R.D. JOHNSON & ASSOCIATES, P.C., 20 PICKERING STREET, P.O.BOX 920353, NEEDHAM, MA, 02492, US

(73) Assignee: SENTIAL, LLC, Salem, MA (US)

(21) Appl. No.: 12/297,207

(22) PCT Filed: Apr. 13, 2007
(86) PCT No.: PCT/US07/66636

§ 371 Date: Oct. 14, 2008

Related U.S. Application Data
(60) Provisional application No. 60/744,821, filed on Apr. 13, 2006.
(60) Provisional application No. 60/869,105, filed on Dec. 7, 2006.
(60) Provisional application No. 60/894,452, filed on Mar. 12, 2007.

(51) Int. Cl. G08B 21/00; A43B 23/26; A43B 13/00

(52) U.S. Cl. 340/870.16; 36/54; 36/25 R

(57) ABSTRACT

A wear monitor for footgear can indicate when a shoe or component may have exceeded its expected useful life. The indication can be triggered by a measure of use, such as steps taken or distance accrued in the shoes, either through estimation or actual measurements. The monitor can take into account varies parameters related to the individual wearer of the shoe and environmental factors to more accurately determine when a pair of shoes has reached a wear out period. By employing sensors, the monitor can also be measure certain operating parameters of the shoe, such as the loss of a critical amount of resilience, and indicating to the wearer that the shoes are no longer adequate to protect the wearer from injury. The wear monitor can be fabricated into the shoe during manufacturing or can be a portable stand-alone device and can employ various technologies to provide a status indication to the wearer.

### RELATED APPLICATION(S)

This application claims the benefit of U.S. Provisional Application No. 60/894,452, filed on Mar. 12, 2007; U.S. Provisional Application No. 60/869,105, filed on Dec. 7, 2006; and U.S. Provisional Application No. 60/744,821, filed on Apr. 13, 2006. The entire teachings of the above applications are incorporated herein by reference.

### BACKGROUND

Shoes wear out and degrade over time, eventually becoming uncomfortable and harmful to the wearer. Because shoes wear slowly, the wearer may not be aware of the potential harm. As a result, many people wear their shoes beyond the recommended life of the shoe, and expose themselves to various injuries.

The harm to the wearer is magnified when the shoe is a running shoe and the wearer is a recreational or professional runner. Runners may be susceptible to a wide range of injuries particularly muscle tears, sprained knees, and various foot injuries. If left untreated, these injuries may lead to more serious conditions that may require medical attention. Podiatrists recommend replacing shoes frequently to prevent moderate injuries caused by running.

It is therefore advantageous to replace running shoes based on usage (such as accrued distance) rather than based on visual appearance or symptoms of pain in the knees or ankles. Running shoes, in particular, have a recommended useful life as estimated by the manufacturer—typically 300 to 500 miles. Runners typically employ a written log to track miles run in a pair of shoes and replace the shoes when the estimated shoe life is exceeded. However, many people may not be disciplined enough to maintain an accurate running log and may have trouble determining when their running shoes need to be replaced.

In addition to running shoes, other sporting goods have components that wear out over time to the point where they can be unsafe. Examples include wheeled sporting goods such as bicycles, skate boards, roller skates, inline skates, and other wheeled shoes, that include a wheel and associated components such as an axle, bearings, or mounts. One type of wheeled shoe, which have become popular with children in recent years, has a wheel embedded in the sole. One shoe brand, HEALYS, features a small wheel that is always partially exposed from the heel area. By leaning back at the proper angle, the user is able to switch from walking to rolling as weight shifts to the wheel. Those wheeled shoes break down and wear over time.

### SUMMARY

Accordingly, there is a need to provide a wear monitor that can indicate when a shoe or component may have exceeded its expected useful life. The indication can be triggered by a measure of use, such as steps taken or distance accrued in the shoes, either through estimation or actual measurements. The monitor can take into account varies parameters related to the wearer of the shoe and environmental factors to more accurately determine when a pair of shoes has reached a wear out period. By employing sensors, the monitor can also be measure certain operating parameters of the shoe, such as the loss of a critical amount of resilience, and indicating to the wearer that the shoes are no longer adequate to protect the wearer from injury. The wear monitor can be fabricated into the shoe during manufacturing or can be a portable stand-alone device and can employ various technologies to provide a status indication to the wearer.

In accordance with aspects of the invention, a shoe-mounted or shoe-integrated device can monitor shoe usage and indicate when the shoe has exceeded its useful life. The device can estimate distances run or can measure the shoe's operating parameters, such as cushioning. In a particular embodiment, the device can include a sensing unit, a programmable processor interpreting data from the sensing unit, and an indicator for notifying the wearer of the shoes' status. The processor can be programmed during manufacturing to incorporate typical variable values that are relevant to measuring shoe life. The processor can also be field programmed by the retailer or end user to enter individualized, wearer-specific variable values.

In accordance with other aspects of the invention, a monitor can measure usage and indicate when a wheel, or other associated component, has exceeded its useful life. The monitor can estimate distance based on the number of rotations the wheel has completed. In particular embodiments, the wheel is part of a shoe or skate boot and the monitor is mounted to or within the shoe or boot.

In one particular embodiment, the wear monitor can be a portable stand-alone device that can be mounted to a shoe. In particular, the device can measure, record, and display the distance accrued or an indicator of such on a pair of shoes. The device can thereby assist the user in determining when replacement of the shoes may be necessary. In another particular embodiment, the wear monitor is integrated into the shoe.

A particular embodiment can include a device for monitoring wear to a component of footgear based on the expected functional life of the component, as determined by a predetermined number of events. The device can include a sensor, a processor, and a display.

The sensor can detect events of the footgear due to activity of a wearer. The events can be impact events or rotational events, but are not limited to such events. For detecting impact events, the sensor can be an accelerometer responsive to motion. For detecting rotational events, the sensor can be a Hall-effect sensor, which can be responsive to a rotating element, such as a Ferris element.

The processor can count the events detected by the sensor and maintain a cumulative event total. The processor can then compares the cumulative event total to an event threshold, which can be calculated from the predetermined number of events and an individualized factor. The individualized factor can include at least one of the wearer's weight, the climate where the footgear is worn, a type of predominate surface on which the footgear is worn, the wearer's age, the wearer's foot pronation or running style (such as whether the user is a heel striker or toe striker), and the wearer's injury history.

The display indicates the relationship between the cumulative event total and the event threshold.

The sensor, processor, and display can be secured within a single housing. The housing can be weather-resistant and/or flexible. When the footgear is a shoe having a tongue, the housing can be integrated into the tongue.

The component or components being monitored depends on the type of footgear. In the case of a shoe, the component can be a sole of the shoe. The component can include a wheel. In particular, the wheel can be replaceable with any of a plurality of wheels. In the case of such wheeled footgear, the processor can maintain a count of events experienced by each individual wheel.

Another particular embodiment can include a method for estimating wear to a component of footgear based on the expected functional life of the component, as determined by a predetermined number of events. The method can include calculating an event threshold based on the predetermined number of events and an individualized factor, counting the events detected by a sensor, maintaining a cumulative event total, and comparing the cumulative event total to the event threshold. The method can also include displaying a representation of the comparison on a display device.

The individualized factor can include at least one of the wearer's weight, the climate where the footgear is worn, and a type of predominate surface on which the footgear is worn, the wearer's age, the wearer's foot pronation or running style (such as whether the user is a heel striker or toe striker), and the wearer's injury history.

In yet another particular embodiment, a shoe can include a monitor for estimating wear to a component of the shoe based on the expected functional life of the component, as determined by a predetermined number of events. The shoe can include a sensor, a processor, and a display.

The sensor can detect events of the shoe due to activity of a wearer;

The processor can calculate an event threshold based on the predetermined number of events and individualized factor, count the events detected by a sensor, from the counting, maintain a cumulative event total, and compare the cumulative event total to the event threshold. The individualized factor can include at least one of the wearer's weight, the climate where the shoe is worn, and a type of predominate surface on which the shoe is worn, the wearer's age, the wearer's foot pronation or running style (such as whether the user is a heel striker or toe striker), and the user's injury history.

The display indicates the relationship between the cumulative event total and the event threshold.

More specifically, the shoe can include a tongue in which at least the processor is housed.

The component or components being monitored depends on the type of shoe. The component can be a sole of the shoe and the events can be impacts. The component can include a wheel and the events can be rotations of the wheel. Furthermore, the wheel can replaceable by one of a plurality of wheels, in which case the processor can maintain a count of events experienced by each individual wheel.

### BRIEF DESCRIPTION OF THE DRAWINGS

The foregoing and other objects, features, and advantages of the invention will be apparent from the following more detailed description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic block diagram of an exemplary embodiment of a wear monitor.

FIG. 2 is a front perspective view of an exemplary embodiment of the wear monitor of FIG. 1 as a portable stand-alone device.

FIGS. 3A and 3B are a top perspective view of the top of a particular housing and a top perspective view of the bottom of the particular housing, respectively.

FIG. 4 is a hypothetical chart comparing cushioning level against impacts for a particular shoe model and size.

FIGS. 5A-5B are a side view and a front view, respectively, depicting placement of the visual indicator on the shoe exterior.

FIG. 6 is a front view of a variable graphic display integrated into the shoe tongue.

FIG. 7 is a front view of a numerical display integrated into the shoe tongue.

FIG. 8 is a schematic of a chemical-based color changing indicator.

FIG. 9 is a schematic of the color changing indicator of FIG. 8 with a ruptured diaphragm.

FIG. 10 is a schematic of a particular rotation-based wear monitor.

### DETAILED DESCRIPTION

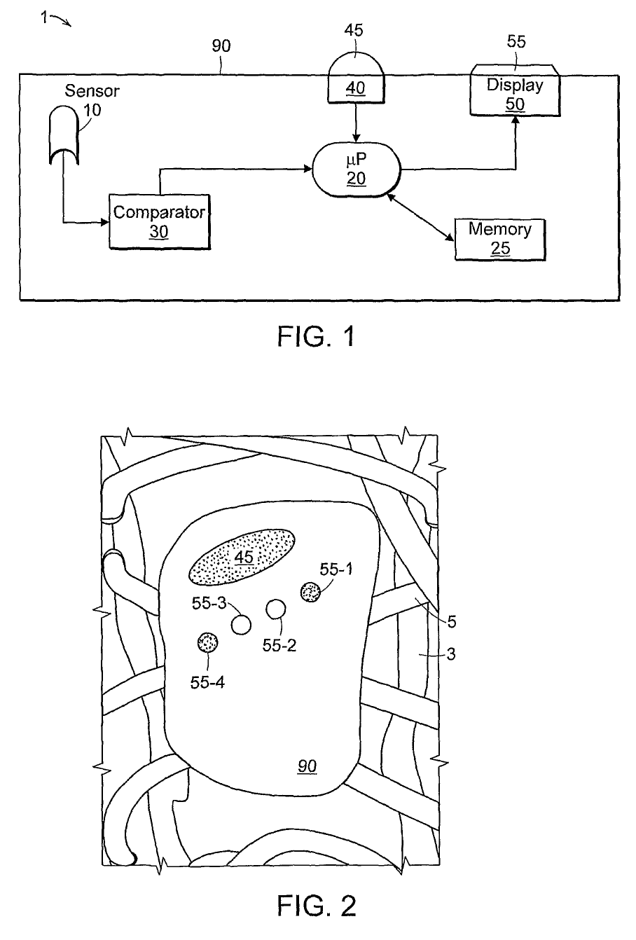

FIG. 1 is a schematic block diagram of an exemplary embodiment of a wear monitor. As shown, the wear monitor includes a sensor 10, a microcontroller unit 20 in communication with a memory 25, a comparator 30, an activation switch 40, and a display unit 50 enclosed within a housing 90. Power for the electrical components is provided by one or more batteries (not shown)

The sensor 10 is triggered in response to movement or another operational indicator that a step has been taken, such as impact of the shoe with the ground or flexing of the shoe. Exemplary sensors can include suitable detectors used in pedometers including, but are not limited to, g-force sensors, flex sensors, accelerometers, piezoelectric devices, etc. In particular, the sensor 10 counts the number of steps taken in a given pair of shoes or provides a signal to a microcontroller indicating that a step has been taken. In one particular embodiment, the sensor 10 is a g-force sensor that transmitted a signal when an impact (step) is detected.

As shown, the comparator 30 is electrically disposed between the sensor 10 and the microcontroller 20. Without providing current, a piezoelectric sensor 10, for example, can produce a low level current when activated, i.e. when it is deformed. Therefore the comparator 30 is used in conjunction with the piezoelectric sensor 10 to check the output from the sensor 10 against its given reference voltage. Any time the reference voltage is reached, the comparator 30 will transmit a digital pulse to the microcontroller 20, which will count the event. As long as the voltage is not reached, the comparator 30 will not transmit a digital pulse and the microcontroller 20 will not register an event. When used in this fashion, a significant amount of battery power can be conserved because voltage does not have to be consistently supplied to the sensor 10, which could reduce battery reserves.

As outlined, the sensor 10 communicates with the microcontroller 20, such as by sending a signal to the microcontroller 20 when triggered or by communicating data representing a measurement. In response, the microcontroller 20 is programmed to count and record the number of steps and, optionally, from the step data estimate and record the cumulative distance traveled by the shoe.

In particular, the microcontroller 20 counts the number of signals emitted from the sensor 10 indicating the number of steps or translates the number of steps into an approximate mileage. The microcontroller 20 records the number of steps or the estimated distance traveled in the memory 25, which in particular is a static memory. Using the memory 25, the microcontroller can operate on multiple data records, so that a stand-alone device can be used on multiple pairs of shoes and by multiple users.

The activation switch 40 initiates monitoring by the device 1. For example, the activation switch 40 can send a signal to the microcontroller 20 to initiate monitoring when its activation button 45 is first depressed. Subsequent depressions of the activation button 45 can send one or more signals to the microcontroller 20 causing the microcontroller 20 to send one or more signals to the display unit 50 to indicate the measured shoe wear. Depressing the activation button 45 can also place the microcontroller 20 into distinct modes, such as alternate shoes or users.

Status of the shoe, as computed by the microcontroller, is communicated to the wearer by the display unit 50, which includes a display indicator 55, such as a light-emitting diode (LED) display or liquid crystal display (LCD) panel. For example, when a critical number of cumulative steps, or distance, has been counted by the microcontroller 20 a display indicator 55 illuminates or otherwise signals that the shoe on which the device is mounted has reached a critical point. A critical point can be understood as a point that may indicate a predetermined number of steps or distance accrued in the shoe, or a predetermined level of cushioning has been lost. Depending on how the microcontroller 20 is programmed, one or more critical points may exist at various intervals, including when the shoe is first used (i.e. when the device is activated) up to and including when the shoe needs to be replaced.

The device can have a number of display indicators 55 corresponding to various critical points, wherein each one illuminates at a predetermined number of steps or distance. For example, four LED's can be utilized indicating 300, 400, 500 and 600 miles or the shoe's health status of “excellent”, “good”, “poor” and “replace”. However, it should be appreciated that more or less than four LED's can be used. The display indicator 55 can also display a percentage of life remaining, either graphically or numerically, similar to an automobile fuel gauge.

A stand-alone monitor can also be used to measure the shoe's operating parameters, such as the level of cushioning provided by the shoe. In such an embodiment, appropriate sensors 10 can be embedded in the shoe, such as the sole, either during manufacturing or as an after-market accessory. In particular, sensor data can be stored in the memory 25 onboard the shoe and retrieved later by a reader with analytical software.

It should be understood that the wear monitor 1 can be a portable stand-alone unit or integrated into the shoe. It should also be understood that certain components can be integrated into the shoe (such as sensors 10) while other components are removable or otherwise portable (such as the microcontroller 20 and display unit 50). To maintain user comfort, the integrated housing 90 can be fabricated from pliable materials and flexible circuit boards can be employed within the housing. Those of ordinary skill in the art will also recognize additional embodiments, some of which will be discussed in more detail below.

FIG. 2 is a front perspective view of an exemplary embodiment of the wear monitor of FIG. 1 as a portable stand-alone device. As shown, the device housing 90 is mounted on a shoe 5, such as in the forward tongue area via attachment to the shoelace 7. Particularly shown are the activation button 45 and four colored LED indicators 55-1, 55-2, 55-3, 55-4 to visually convey the wear status of the shoe to the user. Based on customer preference the wear monitor 1 can be discarded along with the shoe when a certain mileage is reached, or the wear monitor 1 can be reset and reused with a new shoe.

When depressed or otherwise actuated, the activation button 45 initiates counting by the microcontroller 20. Once counting has been initiated, additional depressions of the activation button 45 cycles the microcontroller 20 through various functions, including to cause the display indicator 55 to show the user the accrued distance measured. As described above, the light display 55 can include one or more lights, however it should be appreciated that a single display indicator 55 capable of emitting various colors or a display, such as a digital readout, capable of indicating the number of steps or mileage can also be used.

An attachment feature provides a mounting hole, such as a channel, through which a shoelace can pass for securing the device to the shoe. The attachment feature can also include a clip to attach the device to the shoelace or other portion of the shoe, such as the tongue, shoe lace holes, or the body of the shoe itself.

The wear monitor 1 can be attached to the shoe 5 in a non-obtrusive manner. For example, the profile of the wear monitor 1 can be relatively low. The housing 90 can be constructed of a flexible or polymeric material, which may be melt processed or molded to form a desired shape. The wear monitor 1 can also be illuminated to be visible at night or in poor lighting. For example, the housing 90 can include an illuminated material, such as a reflective material, a phosphorescent or fluorescent material. The illuminated material can be a film affixed to the housing structure such as by an adhesive, in-mold decorating, etc.

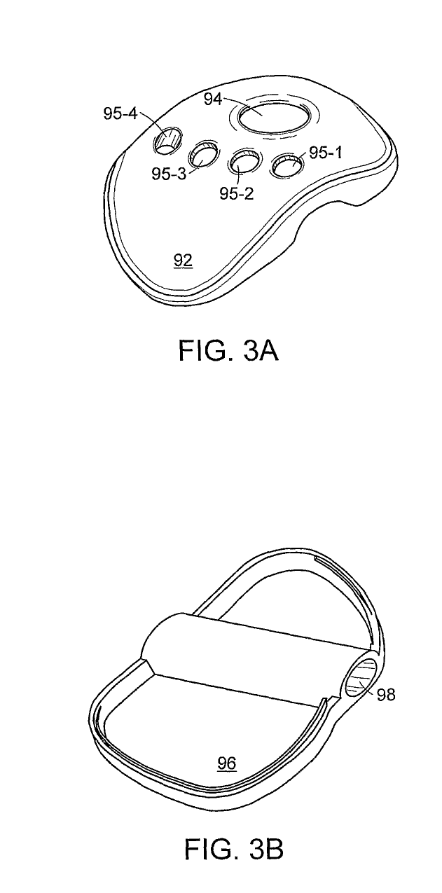

FIGS. 3A and 3B are a top perspective view of the top of a particular housing and a top perspective view of the bottom of the particular housing, respectively. The housing portions 92, 96 are particularly molded from plastic.

The top housing 92 is contoured as desired. As shown, the top portion 92 includes an access opening for the activation button 45 (FIG. 2). Also shown are openings 95-1, 95-2, 95-3, 95-4 for the respective LED's 55-1, 55-2, 55-3, 55-4 (FIG. 2).

The electronic components are situated within a cavity area of the bottom housing 96. However, it should be appreciated that the cavity area can also be located in the top of the housing 92 or a cavity can be formed by both the top and bottom portions of the housing 90.

An attachment through-hole 98 is formed in the bottom housing 96 in the shape of a generally cylindrical channel, as illustrated, or any other suitable shape. The through-hole 98 receives a shoelace to secure the housing 90 to a shoe, as shown in FIG. 2. In addition, more than one attachment option can be used, and more than one channel or other attachment features, such as clips, can be employed.

While a stand-alone shoe monitor is a good general-purpose solution, and can be used for various shoes or users, there are additional advantages to embedding a wear monitor into the shoes during manufacturing. By incorporating the housing or individual components into the shoe, the wear monitor can be more easily tailored to the particular shoe's characteristics. In addition, the sensor or sensors can be strategically placed within the shoe.

A shoe's performance can be quantified by measuring the amount of cushioning provided by the sole. Through testing, manufactures can relate cumulative step impacts with cushioning performance. Counting step impacts can therefore be a reliable indicator of cushioning.

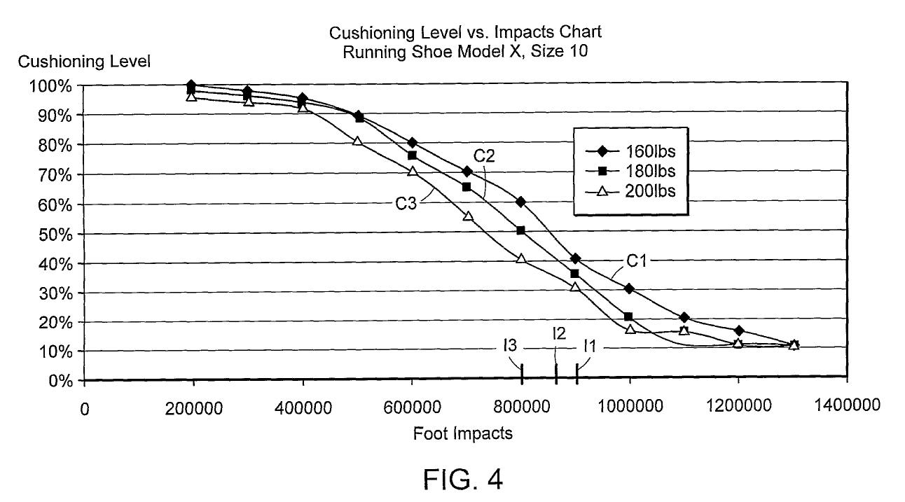

FIG. 4 is a hypothetical chart comparing cushioning level against impacts for a particular shoe model and size. As illustrated, the chart is prepared by a shoe manufacturer (or third party) to associate impacts with cushioning. For example, specific shoe models are subjected to simulated running forces and conditions. The amount of compression/recovery of the cushioning is then measured over multiple conditions and varying distances.

The loading is varied to represent runners of varying weights, and the test bed can also be varied to include different climates and running surfaces. As shown, curves are provided for a plurality of runners of different weights. One curve C1 is associated with 160 pound runners, a second curve C2 is associated with 180 pound runners, and curve C3 is associated with 200 pound runners.

As shown, the shoe maintains a high level of cushioning for a first number of impacts. After that number of impacts, the shoe's cushioning steadily decreases over a second number of impacts. Finally, the shoe's cushioning level bottoms out. At some point, the manufacturer recommends that the shoe be replaced.

In the example shown, it is assumed that the shoe should be replaced when the cushioning level fall below 40%. Based on the data, at a specified number of impacts I1, I2, I3, the manufacture recommends that the shoe be replaced. As illustrated, however, additional variable can be considered to improve that replacement estimate. Referring to the chart, a 160 pound runner should replace the shoe after about 900,000 impacts I1, a 180 pound runner should replace the shoe after about 860,000 impacts I2, and a 200 pound runner should replace the shoe after about 800,000 impacts. Additional milestones can be defined to warn the runner as to the approaching replacement period (see FIG. 2).

In a particular embodiment of the invention, the microcontroller 20 executes an algorithm that is specific to the known characteristics of the shoe, based on either laboratory test results or field testing. The algorithm is utilized to determine and indicate to the wearer when the shoe should be replaced to prevent injury or to alert the wearer to a specific level of cushioning. In a particular embodiment, the algorithm included individualized variables.

An example of the algorithm computes a trigger point based upon variables such as, but not limited to, the weight of the runner, climate, running surface, and running intensity, as follows:

T=MTR*W*C*R*A*P*H

where,
T is the trigger point that alerts the runner that shoe replacement is necessary, or that a critical level of cushioning/mileage has been reached;
MTR is the manufacturer's estimated mean time to replacement of the shoe based on foot impacts, mileage, etc.;
W is a weight factor, which is the ratio of the manufacturer's reference weight to the user's weight;
C is a climate factor relative to the manufacturer's expected climate, taking into consideration the average temperature and humidity within geographic location, or based on indoor/outdoor use;
R is a factor related to the user's intensity level and takes into account variables such as whether or not the shoes are used only for running, if the runner competes in competitive road races, etc.;
A is a factor related to the user's age;
P is a factor related to the user's foot pronation or running style, such as whether the user is a heel striker or toe striker; and
H is a factor related to the user's injury history so as to compensate for a runner that is prone to certain injuries.

The algorithm is thus tailored to incorporate shoe-specific details. In some cases, a manufacture may determine that the Mean Time to Replacement varies based on shoe size within the same model of shoe. In addition, the wearer's weight per square inch of sole can also be a useful in the calculation. In such cases, an additional parameter is shoe size.

A wearer's running style may deviate from the running style expected by the shoe manufacturer. For example, the shoe may not adequately compensate for the particular way that the wearer's foot impacts the ground. The amount of deviation can reduce the expected mileage life of the shoe and can be factored into the shoe life calculation.

Furthermore, the algorithm can also be configured to distinguish between running and walking by measuring forces transmitted during an activity, where the forces of running far exceed those during walking. Additionally, the sensitivity of the device can be tuned such that inadvertent impacts encountered during normal handling or shipping are not registered as impacts.

Upon purchase of a running shoe with an integrated sensor, the shoe model would generally be preprogrammed into the processor. The runner's weight and other wearer-specific variable values can then be entered or the device could be pre-programmed with a range of parameters and the consumer could choose the product that best fit their body type, running style, etc. As described above, the indicator can be triggered by cumulative mileage on the shoe, or cushioning/recovery level as developed through laboratory testing. Also, the indicator may be a light array, an LCD display, digital display, or other suitable means.

Several methods of programming or entering variable data can be used, as known in the art, including the use of a USB port (or other) cable connection, wireless transfer of data, or by toggling a manual switch or dial located on the device body. The ability to program the processor allows for a more accurate indication of the optimal time for shoe replacement, or indication of the level of cushioning degradation.

Various sensor units can be employed in an integrated shoe monitor. One solution is to integrate a pedometer sensor into the shoe. Such a system would be similar to the device shown in FIG. 1. A more sophisticated solution could employ other integrated sensors, which can be combined with a pedometer sensor or other sensors.

One example of an addition sensor is a strain gauge, which can be placed underfoot, embedded in the side of the sole, or in another area in which the shoe flexes or changes position as weight or movement is applied during the running/walking motion (such as the tongue). The gauge senses the movement (i.e. torque, flex, or impact) resulting in a resistance change within the circuit. The microcontroller 20 monitors and senses the change in resistance. The microcontroller 20 utilizes that information along with other factors described above. It then calculates the amount of life left in the shoe, utilizing the above calculations and communicates with the user to indicate the shoe's health or amount of life left in the shoe.

In another embodiment, the strain gauge can be positioned to measure resilience of the sole by indicating deflection of the strain gauge. The microcontroller 20 can monitor the deflection over time and report the shoe's status to the wearer.

As another example, a point sensor can be employed to measure deflection at a particular point. In that case, the point sensor can use pneumatic or other techniques to measure motion, such as a deformable pin element and a circuit for computing the amount of deformation of the pin element.

In particular, the pin element is positioned or embedded into the shoe at some given point, such as at the worst-case position in the sole based on the wearer's running style (such as heel striker or toe striker) as determined during fitting or the wearer's past experiences. As the shoe impacts the ground, the pin element embedded into the sole of the shoe deforms. As the pin element deforms, the amount of electrical resistance in the circuit changes. This change is measured by the circuit, which can be integrated at the distal end of the pin element. The shoe monitor then utilizes the data gathered from the pin sensor to determine when the shoe should be replaced.

In another embodiment, an electromagnetic sensor or sensor array is embedded into the sole. In particular, two layers of conductive material are embedded within the shoe's sole, creating an electromagnetic sensor. At time zero, the two layers are separated by a known distance and exhibit a known induction. A step event is determined by a rapid change in induction. Furthermore, over time and repeated use, the mid-layer sole material separating the two conductive materials compresses resulting in a change in induction that can be monitored. A benefit of an electromagnetic sensor over a strain gauge or a point sensor is that the electromagnetic sensor effectively monitors a large area of the sole (up to the entire area of the sole), not just key specific points.

The microcontroller unit 20 (FIG. 1) monitors the changes in current and communicates values to the user. Any of the previously described indication devices can be employed, including an LED array or digital displays.

By using advanced sensors, the shoe monitor can record data that is also relevant to diagnosing the cause of or contributing factor to an injury. For example, a sensor array or a planar electromagnetic sensor can provide data indicating foot strike patterns for analysis. The relevant data would be stored in a suitable memory for later retrieval. To access the data, an interface can be provided to a computer or any programmable device, such as an Apple IPOD device.

The same concept of utilizing personal parameters as the ones described above can also be incorporated to shoes having an external data port, such as the NIKE+IPOD system, available on select NIKE brand running shoes to communicate data with an Apple IPOD device. A suitable algorithm can be programmed into the IPOD software to alert the runner that their shoes should be replaced. In this case, the IPOD device is utilized as the indicator to the runner via the IPOD device screen.

The NIKE+IPOD system is known to be able to monitor the distance a runner attains with each discrete training session. Modification of the software allows the IPOD device to track cumulative mileage on a pair of running shoes. The information is stored in the IPOD device itself Calculations, as the ones described above, are contained in the software of the IPOD device or shoe attachment. When the shoe needs to be replaced, as calculated by the software, a warning is displayed on the IPOD device screen.

It may be necessary for the user to alert or reset the IPOD device when the user purchases a new pair of shoes, or the IPOD device can include software that automatically detects a new pair of shoes, thus starting the counting algorithm over again. The software can include various settings to monitor several pairs of shoes that the user may own and rotate through during their training.

When the shoe monitor is integrated into the shoe, the location of the indicator component can be easily chosen based on aesthetics. The following figures illustrate a few of the indicator designs and location positions, but it should be understood that other designs and locations can be chosen.

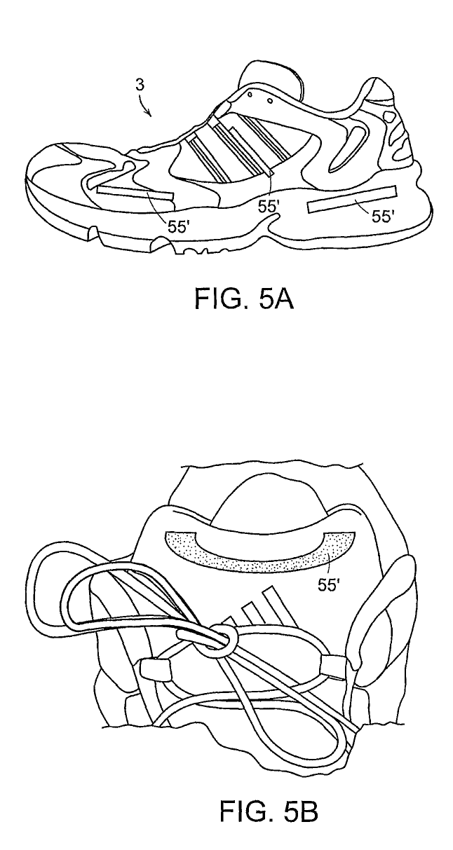

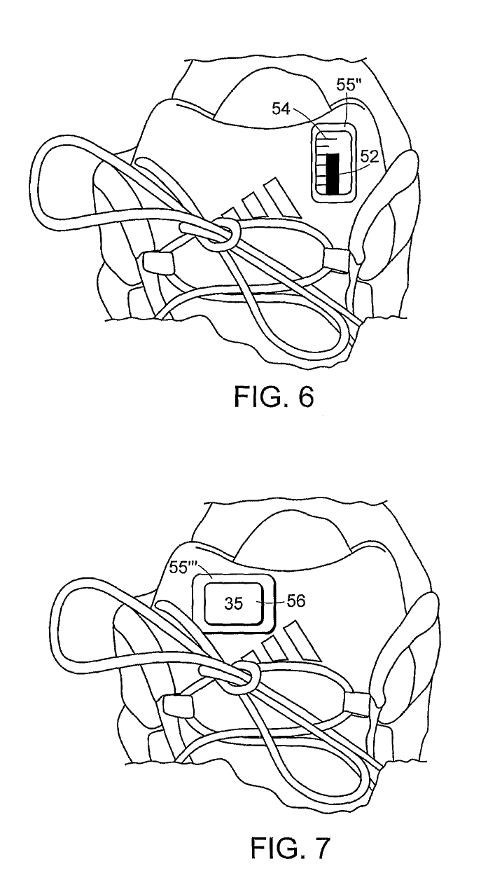

FIGS. 5A-5B are a side view and a front view, respectively, depicting placement of the visual indicator on the shoe exterior. Using any of the previously communicated methods by which to calculate a trigger point, the visual indicators 55′ can light up, change color, or have an LED display information to the user. The indicators can be integrated into the shoe during the molding process, or be integrated into a branding feature of the shoe. The indicator 55′ could be positioned on the exterior of the shoe fabric during manufacturing and secured via mechanical means, or placed using adhesive.

In FIG. 5B, the visual indicator 55′ is integrated into the tongue of the shoe. The electronics could also be contained within the tongue, or elsewhere within the shoe. The indicator display protrudes through the tongue fabric such that the display is always visible to the user. In another embodiment, the display is obscured by a protective flap, which the user pushes aside to reveal the indicator. The flap would also assist in protecting the display from water, dirt, etc.

FIG. 6 is a front view of a variable graphic display integrated into the shoe tongue. As shown, an LCD meter display 55″, with various demarcations 54 indicating either an accrued mileage or a cushioning level. The display 55″ includes a red bar indicator 52, which indicates to the runner the relative amount of recommended life remaining in the shoe.

FIG. 7 is a front view of a numerical display integrated into the shoe tongue. As shown, an LED, LCD, or other numerical-type display 55′″, displays a numeral 56 that indicates the cumulative mileage traveled by the shoe, or some other indication of wear such as cushioning percentage or level, e.g. 80%, etc.

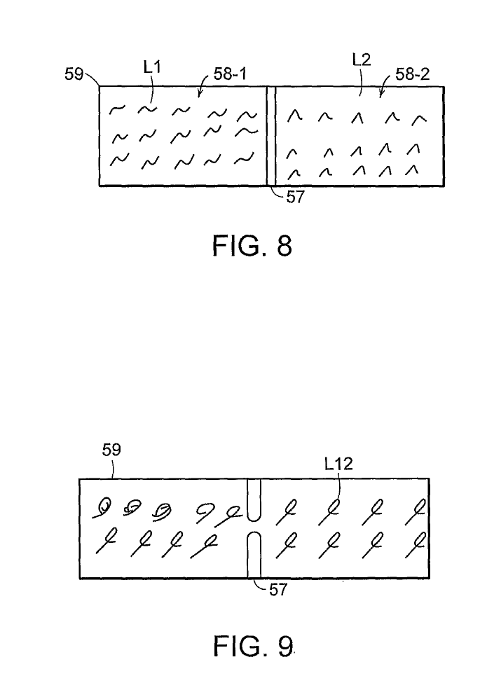

FIG. 8 is a schematic of a chemical-based color changing indicator. The color changing indicator 59 can be a capsule enclosing a plurality of cavities 58-1, 58-2 separated by a breakable diaphragm 57, with each cavity storing a liquid chemical agent L1, L2. To provide a color change indication, the diaphragm 57 is ruptured either electrically or mechanically. When ruptured, the liquid chemical agents L1, L2 mix to produce a colored liquid. That color change provides an indication to the wearer.

In a particular embodiment, the diaphragm 57 is designed to rupture when exposed to an electrical current. The diaphragm 57 is connected to power leads, which ordinarily carry no current. As in previously described embodiments, when the microcontroller 20 (FIG. 1) computes that a critical point has been reached it applies current from the battery to the leads. In response, the diaphragm 57 ruptures causing the two liquids L1, L2 to mix.

FIG. 9 is a schematic of the color changing indicator of FIG. 8 with a ruptured diaphragm. When the diaphragm 57 ruptures, the two liquids L1, L2 mix and react to produce a new colored liquid L12 as shown.

The color change reaction is achieved using a class of chemicals known as indicators. Indicators undergo a color change as a result of changes in pH via the equation:

$$\begin{matrix}H Ind + H 2 O = H 3 O ++ Ind - \\ \begin{matrix}Color A & Color B\end{matrix}\end{matrix}$$

Depending on the chemicals, the mixture either increases or decreases the pH of the resulting solution, thereby initiating the color change.

Note that the display capsule 59 can have more than two cavities and employ more than two chemicals. In that way, by rupturing the diaphragms in a selected sequence, multiple color change steps can be obtained to provide progress information to the wearer, similar to the multiple LED displays of FIG. 2. Also, the capsule can be placed at any desired location on the shoe, including those locations described above.

In another embodiment, the capsule includes a diaphragm that mechanically ruptures. The capsule can be placed within an area of the shoe that experiences stresses with each stride or shoe impact, i.e. where stress is imparted on the polymer diaphragm, such as the heal area. The structure and shape of the diaphragm is engineered to fail after a selected number of cycles or otherwise once a pre-determined stress level is attained. In that case, the diaphragm can be a polymer (such as Polystyrene or Polycarbonate) micro-molded diaphragm. Flex joints formed in the diaphragm degrade and break at a selected impact level to allow mixing of the cavities.

That pre-determined stress level is based upon a mileage, such as 300 miles, or the number of impacts. The particular mechanical structure of the diaphragm is designed to fail and is tuned via mechanical testing of the diaphragm. Through testing, the material thickness at the flex joints is tuned to fail after a specific number of impacts. Again, multiple cavities can also be employed that are separated by multiple diaphragms that are engineered to rupture at a different number of cycles to provide a sequence of colors indicating current status during the life of the shoe.

While the chemical color change indicator of FIGS. 8 and 9 is shown as being rectangular in shape, it can be of any shape. For example, the indicator can be circular in shape with a center cavity separated from a ring shaped outer cavity by a diaphragm. Furthermore, the indicator can be shaped to conform to a logo design.

Power to the shoe monitor is provided by one or more batteries or power cells. In a particular embodiment, a circuit exploits the kinetic energy during foot motion to recharge the batteries during use. Because the batteries need not store enough charge to power to the shoe monitor during shipment, storage, and usage life, a recharging battery can be smaller (and lighter) than a non-recharging battery.

While running shoes are depicted, it should be appreciated that the wear monitor may be used on a variety of active-wear shoes, such as walking shoes, hiking shoes, work boots, military boots, etc. Certain embodiments of the wear monitor can also be useful for footwear worn by people who spend a considerable amount of time standing and therefore rely on shoe cushioning, such as medical and clerical users.

In addition, the concepts of the invention can be applied to wheeled devices, such as bicycles, skate boards, roller skates, inline skates, and other wheeled shoes. Wheeled devices include a wheel and associated components such as an axle, bearings, or mounts that can wear out over time. The components should be timely replaced to prevent injury and optimize performance of the sporting good/wheeled device.

Accordingly there is a need to provide a mileage or wear indication monitor for high-wear components that can alert the user when a component's useful life has been exceeded. The indication can be met by counting the number of rotations accumulated on the wheel. The monitor can take into consideration materials used in the construction of the product, average speed which the user is going, and weight of the user to more accurately measure the mileage and wear on the sporting good or wheeled device.

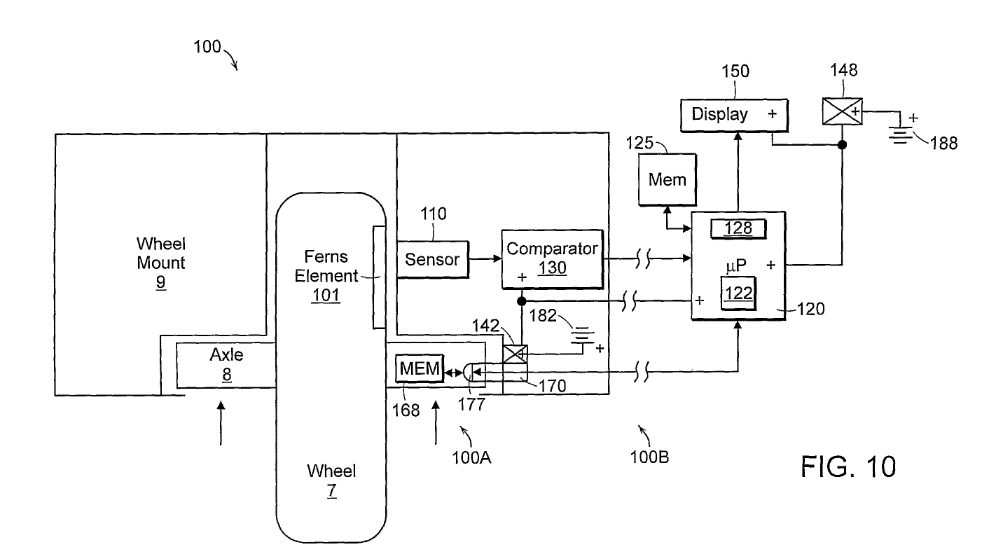

FIG. 10 is a schematic of a particular rotation-based wear monitor. A rotatable wheel 7 and axle 8 are held into position by a wheel mount 9 of the shoe. As in typical products in use, the wheel mount 9 is embedded in or attached to the footgear. In a particular embodiment, the wheel 7 and axle 8 are a single assembly that can be removed and replaced by the user. As such, an individual user may employ multiple wheel assemblies throughout the life of the shoe. In fact, an individual user may have a supply of wheel assemblies, either of which could be used at any particular time. Furthermore, a group of individuals may trade or exchange wheel assemblies. To be most effective, a wear monitor should handle those common situations.

In a particular embodiment, the wear monitor 100 is partitioned between a wheel module 100A and a shoe module 100B. The wheel module 100A is associated with the wheel assembly while the shoe module is associated with the shoe and wheel mount 9. The two modules exchange data via a contact coupling, as will be described below.

The wheel module 100A includes a Ferris element 101 mounted to or embedded within the wheel 7, and a dedicated non-volatile memory 168. As the wheel 7 rotates, the Ferris element 101 also rotates operates as a sensor trip. The dedicated non-volatile memory 168 stores data that is specific to the associated wheel assembly, such as an identifier that is suitably unique to each wheel and cumulative wheel rotations. In a particular embodiment, the wheel identifier can be parsed to indicate the wheel model or type. The dedicated memory 168 can also store manufacturer specific data for the wheel 7, such as the mean time to replacement (MTR).

Also shown is a contact surface 177 for exchanging data in the dedicated memory 168 with circuitry in the shoe module 100B. In another embodiment, data is exchanged over an inductive or other wireless data port, including infrared, radio frequency (e.g. Bluetooth), or optical. It should be understood that the manufacturer can also provide wheel-specific information on the surface of the wheel 7 or axle 8 using, for example, a bar code readable by an optical sensor.

The shoe module 100B is similar to the wear monitor 1 of FIG. 1. In particular, the shoe module 100B includes a sensor 110, a microcontroller 120, a comparator 130, an activation switch 148, and a display module 150.

More particularly, the sensor 110 is a Hall-effect sensor, which is positioned on the wheel mount 9 so as to be tripped by the Ferris element 101 as the wheel rotates in the wheel mount. The sensor 110 thereby registers rotation of the Ferris element 101 and the wheel 7.

The comparator 130 operates as a single bit analog-to-digital converter to convert the analog voltage generated by the sensor 110 in response to proximity of the Ferris element 101 into a digital pulse. That pulse is received and interpreted by a microcontroller 120 as a recognizable event and processed according to the methods discussed below. The cumulative wheel rotations experienced by the wheel mount 9 from all wheels 7 is stored in a static general memory 125.

The display module 150 is used to notify the user as to the status of the wear components. Any of the above-described display techniques can be used. The activation switch 148 is used to operate the display when desired.

Also shown are two battery supplies 182, 188 to power the system. A first battery 182 provides power to the wear monitor 100 during operation. A switch assembly 142 actuates the first battery 182 when the wheel axle 8 is positioned in the wheel mount 9. Because rotation of the wheel 7, by itself, may not be indicative of wheel usage, in that a free spinning wheel exerts negligible wear on components, the axle switch 142 is activated while the wheel is bearing weight, which forces the wheel upward as shown by the arrows. The axle switch 142 also includes a contact point 170 that interfaces with the contact surface 177 on the wheel axle 8 to exchange data between the modules. To accommodate the axle switch 142, the wheel 7 can be unidirectional so that the axle 8 couples to the wheel mount 9 only one way.

When the axle switch 142 is actuated, batter power from the first battery 182 activates the comparator 130 and operational logic 122 in the microcontroller 120. During operation, the microcontroller 120 reads the data stored in the wheel's dedicated memory 168 via the contacts 170, 177. As the wheel 7 rotates, each pulse from the comparator 130 causes the microcontroller 120 to increment the wheel-specific count of wheel rotations in its general memory 125, the count of wheel rotations in the wheel's dedicated memory 168, and the total revolutions from all wheels in the general memory 125.

While the sensor 110 can also be powered, in the illustrated embodiment the Ferris element 101 is optimized to trip the sensor 110 using the electromagnetic field that it generates. In other words, the sensor 110 operates under its own power. The comparator 130 recognizes a trip event and transmits a digital pulse to the microcontroller 120. The illustrated embodiment eliminates the power requirements of the sensor 110 and thus reduces the amount of battery power required for the system 100. Any excess charge can be employed to recharge the batteries 182, 188.

One difference between monitoring the wearable life of a shoe sole and the usable life of wheeled footgear is that the wheels have a relatively short life expectancy and are generally replaceable. In particular, the shoe or boot itself is expected to remain useable after several wheel life cycles, and is typically limited by the life expectancy of the embedded wheel mount 9. As such, the cumulative data stored in the general memory 125 can be used to determine when the wheel mount 9 itself should be replaced or the shoe itself discarded. The display module 150, in that case, is used to signal the user.

The second battery 188 operates the display functions 128 of the microcontroller 120 under the control of the display switch 148. When actuated, the second battery 188 operates the display panel 150 and the display logic 128 in the microcontroller 120. Again, the display panel 150 can provide an indication to the user using any of the above-mentioned techniques.

In a particular embodiment of the invention, the microcontroller 120 executes an algorithm that is specific to the known characteristics of the wheeled device, based on either laboratory test results or field test results. The algorithm is utilized to determine and indicate to the wearer when the wheel, bearings, axle, or mount should be replaced to prevent injury or to alert the wearer when the footgear's performance has been compromised. In particular, the algorithm implements the above-described equation:

T=MTR*W*C*R*A*P*H

where:
T is the trigger point;
MTR is the manufacturer's estimated mean time to replacement of the wheel components based on manufacturing materials, mileage, etc.;
W is a weight factor, which is the ratio of the manufacturer's reference weight to the user's weight;
C is a climate factor relative to the manufacturer's expected climate, taking into consideration the average temperature and humidity within geographic location, or based on indoor/outdoor use;
R is a factor related to the user's intensity level and takes into account variables such as whether or not the wheels are used for high intensity or recreational use, if the user competes in competitions, etc.;
A is a factor related to the user's age;
P is a factor related to the user's foot pronation or running style, such as whether the user is a heel striker or toe striker; and
H is a factor related to the user's injury history so as to compensate for a runner that is prone to certain injuries.

The display 150 can be activated to indicate the remaining expected functional life of the wheel 7 and the wheel mount 9. When the display switch 148 is turned on, the microcontroller processes the data stored in its general memory 125 and displays the information. The display 150 can be an LED array, digital, or LCD or any other device by which to visually communicate a distance measurement, a percentage of remaining life, a critical point in the product lifecycle, or any other suitable indication. It may be advantageous for the display 150 to incorporate the logo design or certain shoe features to maximize aesthetics. The display 150 is positioned so as to not interfere with shoe comfort or function, and it is expected that the most preferred location would be the shoe tongue or heel.

In a particular embodiment, the microcontroller 120 is an Application Specific Integrated Circuit (ASIC) or other suitable logic circuit that responds differently to the two power supplies 182, 188. During operation, that is when the axle switch 142 in communication with the wheel assembly 7, 8 is in the “on” position, the microcontroller 120 counts and records the wheel revolutions. When in display mode, that is when the second user-selectable switch 148 is in the “on” position, the microcontroller 120 processes the stored data to display an indication of wear or remaining useful life to the user. It should be understood that computations can be performed and that additional switching could be utilized to display information at other times, such as when a wheel 7 is coupled or re-coupled to the wheel mount 9.

Although the wear monitor 100 is described with reference to a single wheel per shoe, it is understood that in certain applications, such as inline skates, multiple wheels are simultaneously monitored. In such an application, the display reports the status of individual wheels.

While this invention has been particularly shown and described with references to particular embodiments, it will be understood by those skilled in the art that various changes in form and detail may be made without departing from the scope of the invention encompassed by the patented claims. For example, various features of the embodiments described and shown can be omitted or combined with each other. In addition, the teachings of the invention are not limited to footwear, but can be applied to other sporting goods that have features that deteriorate or otherwise tend to lose performance through use, such as helmets and rackets.

What is claimed is:

1. A device for monitoring wear to a component of footgear based on the expected functional life of the component, as determined by a predetermined number of events, the device comprising:
a sensor to detect events of the footgear due to activity of a wearer;
a processor to count the events detected by the sensor and maintain a cumulative event total and to compare the cumulative event total to an event threshold, the event threshold calculated from the predetermined number of events and an individualized factor; and
a display to indicate the relationship between the cumulative event total and the event threshold.

2. The device of claim 1 wherein the events are impact events.

3. The device of claim 2 wherein the sensor is an accelerometer responsive to motion.

4. The device of claim 1 wherein the events are rotation events.

5. The device of claim 4 wherein the sensor is responsive to a rotating element.

6. The device of claim 5 wherein the rotating element is a Ferris material and the sensor is a Hall-effect sensor.

7. The device of claim 1 wherein the individualized factor includes at least one of the wearer's weight, the climate where the footgear is worn, and a type of predominate surface on which the footgear is worn, the wearer's age, the wearer's foot pronation, and the wearer's injury history.

8. The device of claim 1 further comprising a housing for the sensor, the processor, and the display.

9. The device of claim 8 wherein the housing is weather resistant.

10. The device of claim 8 wherein the housing is flexible.

11. The device of claim 8 wherein the footgear is a shoe having a tongue, and the housing is integrated within the tongue.

12. The device of claim 1 wherein the footgear is a shoe and the component is a sole of the shoe.

13. The device of claim 1 wherein the component includes a wheel.

14. The device of claim 13 wherein the wheel is replaceable.

15. The device of claim 14 wherein the processor maintains a count of events experienced by each individual wheel.

16. The device of claim 1 further comprising a comparator between the sensor and the processor.

17. The device of claim 1 wherein the display is integrated into a logo design on the footgear.

18. The device of claim 1 wherein the display changes color when the relationship reaches a specific value.

19. The device of claim 18 wherein the display includes a chemical indicator.

20. A method for estimating wear to a component of footgear based on the expected functional life of the component, as determined by a predetermined number of events, comprising:
calculating an event threshold based on the predetermined number of events and an individualized factor;
counting the events detected by a sensor;
from the counting, maintaining a cumulative event total;
comparing the cumulative event total to the event threshold.

21. The method of claim 20 further comprising displaying a representation of the comparison on a display device.

22. The method of claim 21 wherein displaying comprises illuminating a portion of a logo design.

23. The method of claim 20 wherein the individualized factor includes at least one of the wearer's weight, the climate where the footgear is worn, and a type of predominate surface on which the footgear is worn, the wearer's age, the wearer's foot pronation, and the wearer's injury history.

24. A shoe having a monitor for estimating wear to a component of the shoe based on the expected functional life of the component, as determined by a predetermined number of events, comprising:
a sensor to detect events of the shoe due to activity of a wearer;
a processor for:
calculating an event threshold based on the predetermined number of events and individualized factor;
counting the events detected by a sensor;
from the counting, maintaining a cumulative event total;
comparing the cumulative event total to the event threshold; and
a display to indicate the relationship between the cumulative event total and the event threshold.

25. The shoe of claim 24 wherein the individualized factor includes at least one of the wearer's weight, the climate where the shoe is worn, and a type of predominate surface on which the shoe is worn, the wearer's age, the wearer's foot pronation, and the wearer's injury history.

26. The shoe of claim 24 wherein the shoe includes a tongue in which at least the processor is housed.

27. The shoe of claim 24 wherein the component is a sole of the shoe and the events are impacts.

28. The shoe of claim 24 wherein the component includes a wheel and the events are rotations of the wheel.

29. The shoe of claim 28 wherein the wheel is replaceable by one of a plurality of wheels.

30. The shoe of claim 29 wherein the processor maintains a count of events experienced by each individual wheel.

31. The shoe of claim 24 further comprising a comparator between the sensor and the processor.

32. The shoe of claim 24 wherein the display is integrated into a logo design on the footgear.

33. The shoe of claim 24 wherein the display changes color when the relationship reaches a specific value.

34. The shoe of claim 33 wherein the display includes a chemical indicator.
